(19) United States
(12) Patent Application Publication
(10) Pub. No.: US 2026/0335174 A1
(43) Pub. Date: Oct. 29, 2026

(54) TREATMENT MECHANISM AND MASSAGER

(71) Applicant: FUJI Medical Instruments MFG. CO.,LTD., Osaka (JP)

(72) Inventors: Meiman LIN, Xiamen (CN); Wenwei WANG, Xiamen (CN)

(21) Appl. No.: 19/708,335

(22) Filed: Jun. 15, 2026

Related U.S. Application Data
(63) Continuation of application No. PCT/CN2024/142597, filed on Dec. 26, 2024.

(30) Foreign Application Priority Data
Dec. 28, 2023 (CN) 202311834428.1
Sep. 23, 2024 (CN) 202411330007.X

(51) Int. Cl. A61H 7/00

(52) U.S. Cl. CPC A61H 7/007; A61H 2201/1238; A61H 2201/1664; A61H 2201/169; A61H 2205/062

(57) ABSTRACT

A treatment mechanism includes a rotating shaft, a first treatment arm and a second treatment arm rotatably disposed on the rotating shaft at intervals and having massage portions, and a restricting portion for restricting the first treatment arm and the second treatment arm from rotating along with rotation of the rotating shaft. At least one of the first treatment arm and the second treatment arm is eccentric and inclined relative to the rotating shaft, and includes a main body provided with the massage portion, and a restricted portion fixed relative to the main body. The restricting portion cooperates with the restricted portion to restrict the restricted portion from moving in a circumferential direction of the rotating shaft, while allowing the restricted portion to move in a radial direction of the rotating shaft and in an extending direction of the rotating shaft.

### CROSS REFERENCES TO RELATED APPLICATIONS

This application is a continuation application of International Application No. PCT/CN 2024/142597 filed on Dec. 26, 2024. This application claims priority to Chinese Patent Application Nos. 202311834428.1 filed on Dec. 28, 2023 and 202411330007.X filed on Sep. 23, 2024, with China National Intellectual Property Administration. The entire disclosures of Internations Application No. PCT/CN2024/142597 and Chinese Patent Application Nos. 202311834428.1 and 202411330007.X are hereby incorporated herein by reference.

### BACKGROUND

### Field of the Invention

The present invention relates to the field of massage apparatuses, and in particular to a treatment mechanism and a massager for treating a portion being treated.

### Background Information

In patent document JP2001-112826A, there is disclosed a massage mechanism for imitating the shape of human hands for massaging, where the massage mechanism has a treatment portion capable of massaging the shoulders of a user, and the treatment portion includes a rotating shaft, as well as a first link rod and a second link rod which are formed by a link rod mechanism. The first link rod and the second link rod are driven via the rotating shaft to face each other directly, to perform forward clamping massage on the portion being treated from the front and back sides of a subject being treated.

However, in the massage mechanism described above, in order to enable the first link rod and the second link rod to move cooperatively, a large number of components are required for cooperation, easily leading to a complicated overall structure. Moreover, in addition to providing the clamping massage, the link rod mechanism neither allows for reproducing hand massaging actions including kneading massage, nor does it provide diverse massage experience to the subject being treated.

Furthermore, patent document JP2001-112826A discloses a massage chair, which has a chair back, and a hand-shaped treatment member is disposed on the upper portion of the chair back to treat the shoulders of a subject being treated.

However, in the case of the massage chair described above, the hand-shaped treatment member can easily obstruct the user's movement when he/she gets up after the treatment is completed.

### SUMMARY

In view of the above problems, an object of the present disclosure is to provide a treatment mechanism that helps to simplify the overall structure and reduce the manufacturing costs.

Furthermore, an object of the present disclosure is also to provide a treatment mechanism capable of reproducing the actions of human hands by means of a simple structure, and a massager with the treatment mechanism, providing rich massage experience to a subject being treated.

Furthermore, an object of the present disclosure is also to provide a massager to make it easily for a subject being treated to get up.

To achieve the objects described above, the present disclosure provides a treatment mechanism, including a rotating shaft, a first treatment arm and a second treatment arm rotatably disposed on the rotating shaft at intervals and having massage portions configured to massage a portion being treated, in a manner of approaching each other, with at least one of the first treatment arm and the second treatment arm being eccentric and inclined relative to the rotating shaft, and a restricting portion configured to restrict the first treatment arm and the second treatment arm from rotating along with rotation of the rotating shaft. The at least one of the first treatment arm and the second treatment arm includes a main body provided with the massage portion, and a restricted portion fixed relative to the main body. The restricting portion cooperates with the restricted portion to restrict the restricted portion from moving in a circumferential direction of the rotating shaft, while allowing the restricted portion to move in a radial direction of the rotating shaft and in an extending direction of the rotating shaft.

According to the treatment mechanism of the present disclosure, the at least one of the first treatment arm and the second treatment arm includes the main body provided with the massage portion, and the restricted portion fixed relative to the main body, and the restricting portion cooperates with the restricted portion to restrict the restricted portion from moving in the circumferential direction of the rotating shaft, while allowing the restricted portion to move in the radial direction of the rotating shaft and in the extending direction of the rotating shaft, thereby helping to simplify the overall structure and reduce the manufacturing costs.

Furthermore, in the treatment mechanism of the present disclosure, preferably in the at least one of the first treatment arm and the second treatment arm, the restricted portion is integrally formed with the main body.

According to the treatment mechanism of the present disclosure, in the at least one of the first treatment arm and the second treatment arm, the restricted portion is integrally formed with the main body, thereby enabling further simplification of the overall structure and reduction of the manufacturing costs.

Furthermore, in the treatment mechanism of the present disclosure, preferably, the restricting portion is provided with a guide slot, the guide slot extends in parallel to the rotating shaft and is configured to allow for insertion of the restricted portion, and the guide slot is configured to restrict the restricted portion from moving in a slot width direction, while allowing the restricted portion to move in a slot length direction and a slot depth direction.

According to the treatment mechanism of the present disclosure, the restricting portion has the guide slot, and the guide slot extends in parallel to the rotating shaft and is configured to allow for insertion of the restricted portion. The guide slot is configured to restrict the restricted portion from moving in the slot width direction, while allowing the restricted portion to move in the slot length direction and the slot depth direction. Therefore, the restricting portion is simple in structure and easy to form.

Furthermore, in the treatment mechanism of the present disclosure, preferably, the massage portion of the first treatment arm and the massage portion of the second treatment arm have different motion trajectories.

According to the treatment mechanism of the present disclosure, the massage portion of the first treatment arm and the massage portion of the second treatment arm have different motion trajectories, thereby helping to enhance the variety of massage modes.

Furthermore, in the treatment mechanism of the present disclosure, preferably, the massage portion of the first treatment arm and the massage portion of the second treatment arm have different shapes.

According to the treatment mechanism of the present disclosure, the massage portion of the first treatment arm and the massage portion of the second treatment arm have different shapes, thereby helping to enhance the variety of massage modes.

Furthermore, in the treatment mechanism of the present disclosure, preferably, the first treatment arm and the second treatment arm each include the main body and the restricted portion fixed relative to the main body, and the massage portion of the first treatment arm is detachably disposed on the main body of the first treatment arm.

According to the treatment mechanism of the present disclosure, the first treatment arm and the second treatment arm each include the main body and the restricted portion fixed relative to the main body, and the massage portion of the first treatment arm is detachably disposed on the main body of the first treatment arm. Therefore, the desired massage portion of the first treatment arm can be changed flexibly as required.

Furthermore, in the treatment mechanism of the present disclosure, preferably, a portion of at least one of the massage portions of the first treatment arm and the second treatment arm, in contact with the portion being treated, is spherical.

According to the treatment mechanism of the present disclosure, the portion of at least one of the massage portions of the first treatment arm and the second treatment arm, in contact with the portion being treated, is spherical, thereby helping to prevent the portion being treated from being injured.

Furthermore, in the treatment mechanism of the present disclosure, preferably, the second treatment arm is provided with a plurality of massage portions arranged in a straight line.

According to the treatment mechanism of the present disclosure, the second treatment arm has the plurality of massage portions that are arranged in a straight line, thereby helping to increase the massage area.

Furthermore, in the treatment mechanism of the present disclosure, preferably, the first treatment arm and the second treatment arm are each eccentric and inclined relative to the rotating shaft, an eccentricity of the first treatment arm relative to the rotating shaft is different from an eccentricity of the second treatment arm relative to the rotating shaft, and/or, an inclination of the first treatment arm relative to the rotating shaft is different from an inclination of the second treatment arm relative to the rotating shaft.

According to the treatment mechanism of the present disclosure, the first treatment arm and the second treatment arm are each eccentric and inclined relative to the rotating shaft, the eccentricity of the first treatment arm relative to the rotating shaft is different from the eccentricity of the second treatment arm relative to the rotating shaft, and/or, the inclination of the first treatment arm relative to the rotating shaft is different from the inclination of the second treatment arm relative to the rotating shaft, thereby helping to enhance the variety of the massage modes.

Furthermore, in the treatment mechanism of the present disclosure, preferably, the treatment mechanism further includes a motor configured to drive the rotating shaft to rotate, the motor being disposed between the first treatment arm and the second treatment arm in the extending direction of the rotating shaft, and extending perpendicularly to the rotating shaft.

According to the treatment mechanism of the present disclosure, the treatment mechanism further includes the motor configured to drive the rotating shaft to rotate, the motor being disposed between the first treatment arm and the second treatment arm in the extending direction of the rotating shaft, and extending perpendicularly to the rotating shaft, thereby helping to compactly construct the treatment mechanism to achieve the miniaturization of the treatment mechanism.

Furthermore, in the treatment mechanism of the present disclosure, preferably, the first treatment arm includes a first main body with a first massage portion, and a first restricted portion fixed relative to the first main body, the second treatment arm includes a second main body with a second massage portion, and a second restricted portion fixed relative to the second main body, the first main body has a first plate-like portion extending in a manner of intersecting with the rotating shaft, and a protruding portion protruding toward the second treatment arm at an end of the first plate-like portion opposite to the restricting portion, with the first massage portion being disposed at a front end of the protruding portion, and the second main body has a second plate-like portion extending in a manner of intersecting with the rotating shaft, with the second massage portion being disposed at an end of the second plate-like portion opposite to the restricting portion.

Furthermore, to achieve the objects described above, the present disclosure provides a massager including the treatment mechanism according to any one of the above.

Furthermore, to achieve the objects described above, the massager of the present disclosure further includes a frame, and a shoulder treatment unit including a fixed portion connected and fixed to the frame, a movable portion having the treatment mechanism, the treatment mechanism being supported on the frame via the fixed portion and being movable in a shoulder width direction relative to the fixed portion, and a force application portion configured to drive the movable portion to move back and forth.

According to the massager of the present disclosure, when a subject being treated gets up after the treatment has been completed, the movable portion having the treatment mechanism can be prevented from interfering with the shoulders of the subject being treated, by moving the movable portion toward the outer side in the shoulder width direction using the force application portion, thereby making it easily for a subject being treated to get up.

Furthermore, in the massager of the present disclosure, preferably, the force application portion has a telescopic component that is configured to extend and retract to enable the movable portion to move back and forth.

Furthermore, in the massager of the present disclosure, preferably, the telescopic component includes an elastic component that is disposed between the fixed portion and the movable portion, the elastic component being configured to apply force to the movable portion toward the outer side in the shoulder width direction.

According to the massager of the present disclosure, when the massager is in a non-operating state, for example, after completing massaging, when powered off or the like, the movable portion can naturally return to the outer side in the shoulder width direction, thereby easily achieving energy saving while making it easily for a subject being treated to get up.

Furthermore, in the massager of the present disclosure, preferably, the telescopic component includes an airbag that is disposed between the fixed portion and the movable portion, the airbag being configured to apply, during inflation, a force to the movable portion toward an inner side in the shoulder width direction.

According to the massager of the present disclosure, when the massager is in a non-operating state, for example, after completing massaging, when powered off or the like, the movable portion is facilitated to return to the outer side in the shoulder width direction, thereby easily achieving energy saving while making it easily for a subject being treated to get up.

Furthermore, in the massager of the present disclosure, preferably, the fixed portion has a guide rail extending along the shoulder width direction, and the movable portion has sliders engaged with the guide rail in a manner of enabling the sliders to slide relative to the guide rail.

Furthermore, in the massager of the present disclosure, preferably, each of the sliders has an upper abutting portion abutting against the guide rail from above, and a lower abutting portion abutting against the guide rail from below.

According to the massager of the present disclosure, during a massage process, even if the treatment mechanism is subjected to a reaction force from the shoulders of the subject being treated, the position of the movable portion in the up-and-down direction can still be easily maintained, ensuring that the massage can be performed according to the settings.

Furthermore, the massager of the present disclosure, preferably, further includes a movement restriction structure disposed between the movable portion and the fixed portion.

According to the massager of the present disclosure, the movement restriction structure is disposed between the movable portion and the fixed portion, and the movement restriction structure regulates the movement range of the movable portion relative to the fixed portion. The movement restriction structure restricts the movement range of the movable portion in the shoulder width direction. In this way, the movable portion can be prevented from excessive movement toward the inner side in the shoulder width direction. The movement restriction structure restricts the movement of the movable portion in the front-to-back direction, and can further ensure that the movable portion only moves in the shoulder width direction relative to the fixed portion, without any deviation in the front-to-back direction.

Furthermore, in the massager of the present disclosure, preferably, the shoulder treatment unit includes a detection portion that is configured to detect movement of the movable portion.

Furthermore, in the massager of the present disclosure, preferably, the shoulder treatment unit includes a control portion that is configured to control an action of the force application portion based on a detection result of the detection portion.

According to the massager of the present disclosure, the shoulder treatment unit includes the control portion, and the control portion controls the action of the force application portion based on the detection result of the detection portion. Therefore, the movement of the movable portion can be precisely controlled.

According to the present disclosure, it is possible to provide a treatment mechanism capable of reproducing the actions of human hands through a simple structure, and a massager with the treatment mechanism.

Furthermore, according to the present disclosure, it is possible to provide a massager, whereby when a subject being treated gets up after the treatment has been completed, a movable portion having a treatment mechanism can be prevented from interfering with the shoulders of the subject being treated, by moving the movable portion toward the outer side in the shoulder width direction using the force application portion, thereby making it easily for a subject being treated to get up.

### BRIEF DESCRIPTION OF THE DRAWINGS

FIG. 1 is a side view schematically showing a frame of a massager according to an embodiment of the present disclosure.

FIG. 2 is a partial top view schematically showing the frame of the massager according to an embodiment of the present disclosure.

FIG. 3 is a perspective view schematically showing a shoulder treatment unit of the massager according to an embodiment of the present disclosure.

FIG. 4A is a side sectional view schematically showing the shoulder treatment unit of the massager according to an embodiment of the present disclosure, and showing a state in which a movable portion S2 is in a retracted position.

FIG. 4B is a side sectional view schematically showing the shoulder treatment unit of the massager according to an embodiment of the present disclosure, and showing a state in which the movable portion S2 is in an extended position.

FIG. 5 is an exploded perspective view schematically showing the shoulder treatment unit of the massager according to an embodiment of the present disclosure.

FIG. 6 is a top view schematically showing a treatment mechanism according to an embodiment of the present disclosure, schematically showing the motion trajectories of a first massage portion and a second massage portion and the motion trajectory of a first restricted structure.

FIG. 7 is a plan view schematically showing a portion of the structure of the treatment mechanism according to an embodiment of the present disclosure.

FIG. 8 is a perspective view schematically showing a portion of the structure of the treatment mechanism according to an embodiment of the present disclosure.

FIG. 9 is a perspective view schematically showing a first treatment arm in the treatment mechanism according to an embodiment of the present disclosure.

FIG. 10 is a perspective view schematically showing a main body of the first treatment arm in the treatment mechanism according to an embodiment of the present disclosure.

FIG. 11 is a perspective view schematically showing a second treatment arm in the treatment mechanism according to an embodiment of the present disclosure.

FIG. 12 is a perspective view schematically showing a treatment mechanism according to a variation of the present disclosure.

FIG. 13 is another perspective view schematically showing the treatment mechanism according to the variation of the present disclosure.

### DETAILED DESCRIPTION OF EMBODIMENTS

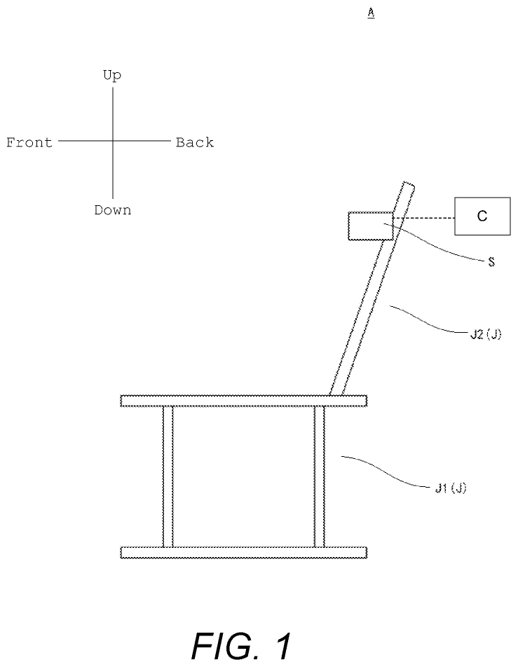

The following illustrates the massager according to the embodiments of the present disclosure with reference to FIGS. 1 to 11.

For convenience of illustration, the orientation of a treated subject seated in the massager during observation is used to describe the structural orientation of the massager. For example, the front side (forward side) of the treated subject seated on the massager during observation is referred to as “front side” or “forward”, the rear side (back side) of the treated subject is referred to as “rear side” or “back”, the upper side (head side) of the treated subject is referred to as “upper side” or “top”, the lower side (foot side) of the treated subject is referred to as “lower side” or “bottom”, the right side of the treated subject is referred to as “right side” or “right”, and the left side of the treated subject is referred to as “left side” or “left”. In addition, the shoulder width direction of the subject sitting on the massager is simply referred to as a “shoulder width direction,” i.e., the left-to-right direction of the massager. The “outer side in the shoulder width direction” corresponds to the direction away from the neck of the subject being treated in the shoulder width direction, and the “inner side in the shoulder width direction” corresponds to the direction close to the neck of the subject being treated in the shoulder width direction.

### Overall Structure of the Massager

As shown in FIGS. 1 to 4B, a massager A has a frame J and shoulder treatment units S having the function of treating the shoulders of a subject being treated. Each shoulder treatment unit S includes a fixed portion S1, a movable portion S2, and a force application portion S3. The fixed portion S1 is connected and fixed to the frame J. The movable portion S2 has a treatment mechanism, is supported on the frame J via the fixed portion S1, and is movable in the shoulder width direction relative to the fixed portion S1. The force application portion S3 drives the movable portion S2 to move back and forth.

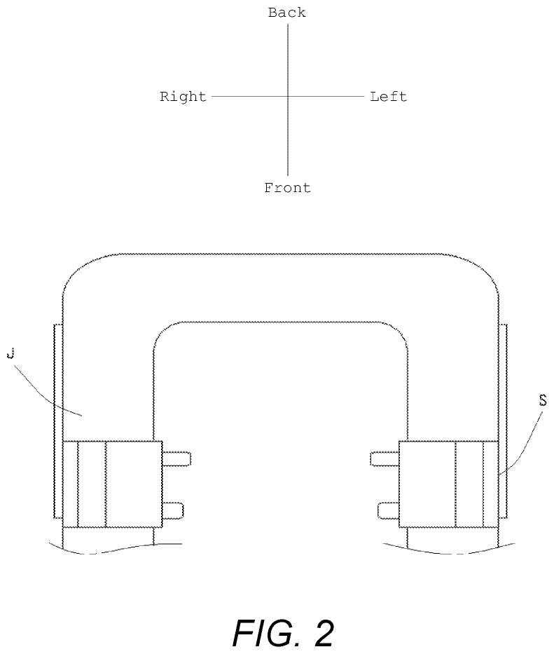

Here, as shown in FIGS. 1 and 2, the massager A is a massage chair. The frame J includes a seat portion J1 and a backrest portion J2. The seat portion J1 allows for seating by a subject being treated. The backrest portion J2 is, for example, rotatably connected to the seat portion J1, and allows for back leaning by the subject being treated. The shoulder treatment units S are disposed on the upper portion of the backrest J2. A left shoulder treatment unit S and a right shoulder treatment unit S are disposed on the left and right sides of the backrest portion J2, respectively. The shoulder treatment units S are arranged in pairs on both left and right sides in the shoulder width direction in a manner that their respective treatment mechanisms are closer to each other than their respective fixed portions S1. That is, the treatment mechanisms of the shoulder treatment units S on both left and right sides are located further toward the inner side in the left-to-right direction than the fixed portions S1.

### Structure of the Shoulder Treatment Unit

As described above, each shoulder treatment unit S includes the fixed portion S1, the movable portion S2, and the force application portion S3.

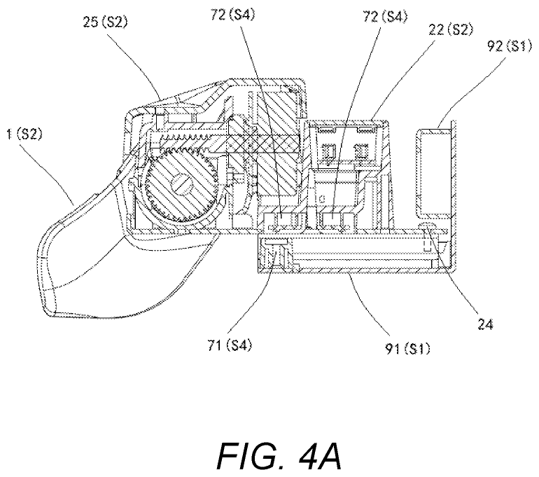

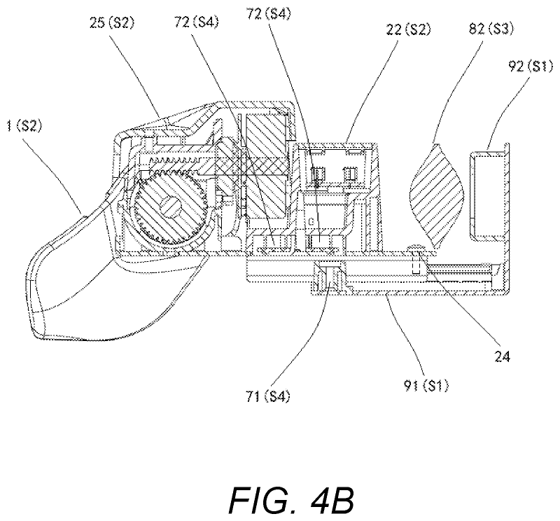

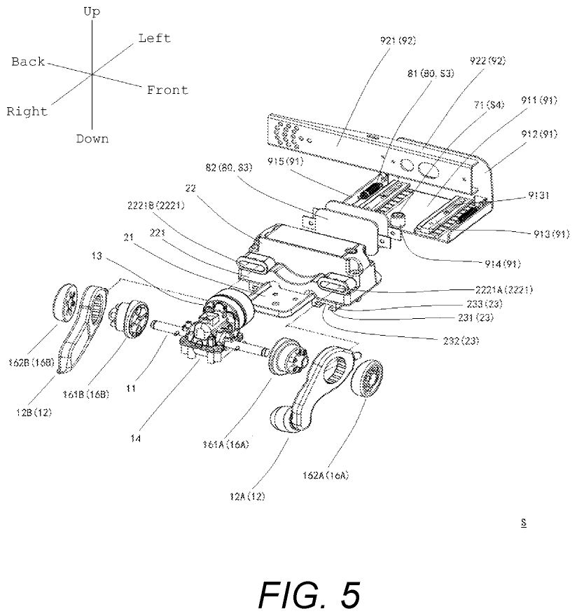

Here, as shown in FIGS. 4A, 4B and 5, each shoulder treatment unit S includes a detection portion or detector S4, and the detection portion S4 detects the position of the movable portion S2 relative to the fixed portion S1.

Furthermore, although not shown, each shoulder treatment unit S further includes a control portion or electronic controller C, and the control portion C controls the action of the force application portion S3 based on the detection result of the detection portion S4. The control portion C is operatively and/or electrically connected to various components of the shoulder treatment unit S, such as the force application portion S3 (a pump or compressor for an airbag 82), the detection portion S4, the drive mechanism 13 (a motor 131), etc., to control the force application portion S3 and the driver mechanism 13 and to obtain the detection result from the detection portion S4. As well known in the field of massagers, the control portion includes at least one processor having a CPU (Central Processing Unit) and a storage device or computer memory, and an interface for communicating with each device is included as necessary. In the illustrated embodiment, each shoulder treatment unit S includes the control portion C. However, the number of the control portions is not limited to this, and the massager A can only include a single control portion, or can include more than two control portions. In the illustrated embodiment, as seen in FIG. 1, the control portion C is illustrated as being located outside the shoulder treatment unit S for simplicity of illustration, but the location is not limited to this. The controller C can be located at any other suitable location on the massager A, such as inside the shoulder treatment unit S.

### 1) Specific Structure of the Fixed Portion

In this embodiment, the fixed portion S1 is fixed to the frame J.

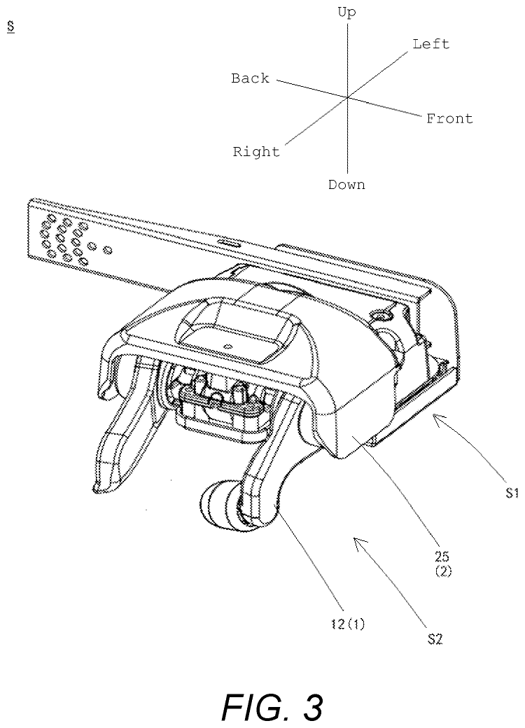

Here, as shown in FIGS. 3 to 5, each fixed portion S1 includes a base 91 and a connecting arm 92. The base 91 holds the movable portion S2. The connecting arm 92 connects and fixes the base 91 to the frame J.

Furthermore, as shown in FIGS. 3 to 5, the base 91 includes a bottom plate 911 and a side plate 912. The thickness direction of the bottom plate 911 is consistent with the up-and-down direction. The bottom plate 911 supports the movable portion S2 from below. A guide rail 913 is disposed on the bottom plate 911, and the guide rail 913 extends in the shoulder width direction. A groove 9131 that is recessed downward relative to guide surface of the guide rail 913 is disposed in a center portion of the guide rail 913 in its width direction (the front-to-back direction). This groove 9131 extends in the shoulder width direction, and allows for insertion of the protrusion 24 described below of the movable portion S2 (refer to FIGS. 4A and 4B, in which a portion of the protrusion 24 is shown with a dotted line). In the shoulder width direction, the length of each of the grooves 9131 is smaller than the length of the guide rail 913. The protrusion 24 moves within the length range of the groove 9131 in the shoulder width direction. A mounting portion 914 is further disposed on the bottom plate 911, and the mounting portion 914 allows for mounting of constituent elements of the detection portion S4. In this embodiment, a pair of guide rails 913 is arranged at intervals in the front-to-back direction. A side plate 912 is erected upward from an end of the bottom plate 911 at the outer side in the shoulder width direction. The thickness direction of the side plate 912 is consistent with the shoulder width direction. The base 91 further includes a pair of reinforcing plates 915, which are erected upward from both ends of the bottom plate 911 in the front-to-back direction. The thickness direction of each reinforcing plate 915 is consistent with the front-to-back direction. The side plate 912 protrudes further upward than the reinforcing plates 915.

Furthermore, as shown in FIGS. 3 to 5, the connecting arm 92 includes a bottom plate 921. The bottom plate 921 is in the form of an elongated strip extending in the front-to-back direction. The thickness direction of the bottom plate 921 is consistent with the shoulder width direction. A plurality of holes are provided in the bottom plate 921 for connection and fixation with the frame J, the side plate 912 of the base 91, the force application portion S3, etc. The connecting arm 92 further includes a pair of reinforcing plates 922, which are erected from both ends of the bottom plate 921 in the up-and-down direction toward the same side in the shoulder width direction and are erected toward the side plate 912 of the base 91. The thickness direction of each reinforcing plate 922 is consistent with the up-and-down direction. The connecting arm 92 protrudes further rearward than the side plate 912 of the base 91.

### 2) Specific Structure of the Movable Portion

As described above, the movable portion S2 has a treatment mechanism.

Here, the movable portion S2 is movable in the shoulder width direction, thereby moving between a retracted position and an extended position that is closer to the inner side in the shoulder width direction than the retracted position (closer to the neck of the subject being treated than the retracted position). In this embodiment, the retracted position and the extended position are arranged in the left-to-right direction, and have the same position in the up-and-down direction with respect to the massager. When the movable portions S2 of the left and right shoulder treatment units S are both in the retracted position, a distance K1 is between the left and right treatment mechanisms. When the movable portions S2 of the left and right shoulder treatment units S are both in the extended position, a distance K2 is between the left and right treatment mechanisms. The distance K1 is greater than the distance K2. When the distance K1 is greater than the width of the backrest supporting the back of the subject being treated, the seating of the subject being treated is facilitated.

Furthermore, as shown in FIGS. 3 and 5, the treatment mechanism of each movable portion S2 has a treatment assembly 1 and a support body 2. The treatment assembly 1 has: a rotating shaft 11 extending in a direction (i.e., the front-to-back direction in the illustrated example) intersecting the shoulder width direction; and a pair of treatment arms 12 supported on the rotating shaft 11 in a manner of eccentrically rotating relative to the rotating shaft 11. The support body 2 supports the treatment assembly 1 and has a restricting portion 221 that restricts the pair of treatment arms 12 from rotating along with the rotation of the rotating shaft 11.

Furthermore, as shown in FIGS. 3 to 5, the support body 2 has a slider 23, and the slider 23 is engaged with the guide rail 913 in a manner of enabling the slider to slide relative to the guide rail 913. The restricting portion 221 of the support body 2 also has a guide slot 2221, and the guide slot 2221 allows for insertion of the restricted portions 1212A and 1212B of the treatment arm 12 to restrict the motion trajectory of the treatment arm 20.

In this embodiment, as shown in FIGS. 3 to 5, the support body 2 has a support plate 21, a first hood 22 and a second hood 25. The thickness direction of the support plate 21 is consistent with the up-and-down direction. The first hood 22 is disposed above the support plate 21, and the support plate 21 protrudes further toward the inner side in the shoulder width direction than the first hood 22. The first hood 22 has two protruding portions constituting the restricting portion 221, and the two protruding portions protrude further toward both sides in the front-to-back direction than the bottom plate 22. Each restricting portion 221 has a guide slot 2221, and the guide slot 2221 extends in the front-to-back direction and opens toward one side in the shoulder width direction and toward the side of treatment assembly 1. A slider 23 is fixed below the restricting portion 221 of the first hood 22. The slider 23 has: an upper abutting portion 231 abutting against the guide rails 913 from above; and a lower abutting portion 232 abutting against the guide rails 913 from below. The slider 23 also has a connecting portion 233 that connects the upper abutting portion 231 and the lower abutting portion 232. In the illustrated example, a pair of lower abutting portions 232 is disposed at intervals in the front-to-back direction, and the slider 23 as a whole is formed in a C-shape that opens downward. The slider 23 is provided with a protrusion 24, and the protrusion 24 is inserted into the grooves 9131 of the guide rails 913. The protrusion 24 is made of, for example, a screw, and passes through the vicinity of the rear end of the support plate 21 in the up-and-down direction The second hood 25 covers the treatment assembly 1 from above and from both sides in the front-to-back direction, and is detachably connected to the first hood 22.

A pair of sliders 23 is arranged at intervals in the front-to-back direction. The pair of sliders 23 is disposed corresponding to a pair of guide rails 913. The guide rails 913 are inserted into the hollow space formed by the upper abutting portions 231 and the lower abutting portions 232 of the sliders 23 in the left-to-right direction. Therefore, the guide rails are in slidable abutting contact with the upper and lower abutting portions, forming a sliding abutting structure. When the sliders 23 move along the guide rails 913, the upper abutting portions 231 and the lower abutting portions 232 restrict the disengagement of the sliders 23 in the up-and-down direction.

A movement restriction structure is disposed between the sliders 23 of the movable portion S2 and the guide rails 913 of the fixed portion S1. The movement restriction structure restricts the movement range of the sliders 23 in the shoulder width direction. The movement restriction structure includes the above protrusion 24 disposed on each slider 23 and the above groove 9131 disposed on each guide rail 913. Each groove 9131 extends in the shoulder width direction, and each protrusion 24 is arranged corresponding to the groove 9131 and inserted into the groove 9131, and moves within the range of the groove 9131. The protrusion 24 can only move in the shoulder width direction within the length range of the groove 9131, thereby restricting the movement range of the protrusion 24 in the shoulder width direction. Therefore, the movable portion S2 can be prevented from excessive movement toward the inner side in the shoulder width direction. The movement of the protrusion 24 in the width range of the groove 9131 is restricted, making it possible to further ensure that each slider 23 only slides along the guide rail 913 without any deviation in the front-to-back direction.

The sliding abutting structure between the guide rails 913 and the sliders 23 cooperates with the movement restriction structure, making it possible to not only prevent the shoulder treatment unit S from deviation in the left-to-right direction, but also ensure that the shoulder treatment unit S can perform stable treatment actions even if it moves in the left-to-right direction while treating the shoulders (i.e., undergoing a force in the up-and-down direction).

Next, the treatment assembly 1 and the guide slot 2221 cooperating therewith will be described in further detail.

As described above, the treatment assembly 1 includes the rotating shaft 11 and the pair of treatment arms 12.

Here, as shown in FIG. 5, the treatment assembly 1 further includes a drive mechanism 13 and a retaining seat 14. The drive mechanism 13 drives the rotating shaft 11 to rotate. The retaining seat 14 is fixed to the support body 2 and supports the rotating shaft 11 and the drive mechanism 13.

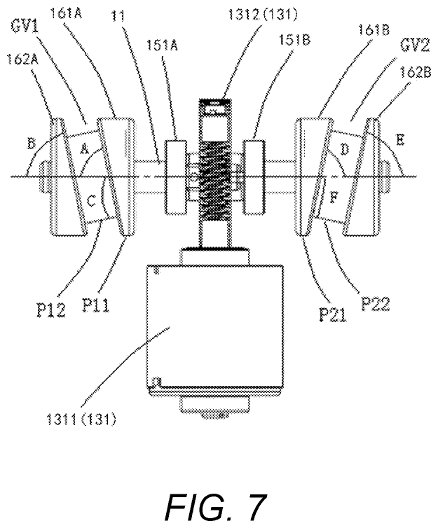

Furthermore, as shown in FIGS. 5 and 7, the rotating shaft 11 extends in the front-to-back direction and is rotatably supported on the retaining seat 14 via a first bearing 151A and second bearing 152A spaced apart in the front-to-back direction.

Furthermore, as shown in FIG. 5, the pair of treatment arms 12 includes a first treatment arm 12A and a second treatment arm 12B. The first treatment arm 12A and the second treatment arm 12B are spaced apart and rotatably disposed on the rotating shaft 11. The first treatment arm 12A and the second treatment arm 12B are each eccentric and inclined relative to the rotating shaft 11 (that is, the respective rotation centers of the first treatment arm 12A and the second treatment arm 12B are inconsistent with the rotation center of the rotating shaft 11, and the extending direction of the respective main bodies of the first treatment arm 12A and the second treatment arm 12B is inclined relative to the extending direction of the rotating shaft 11).

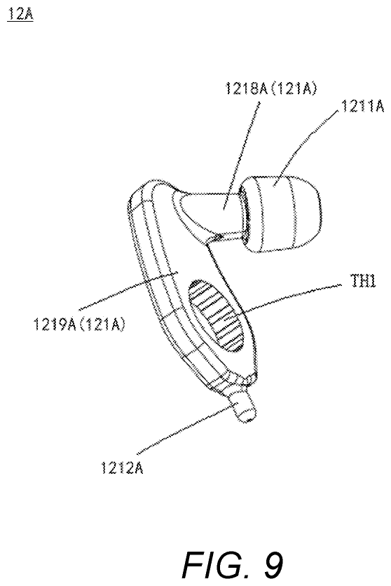

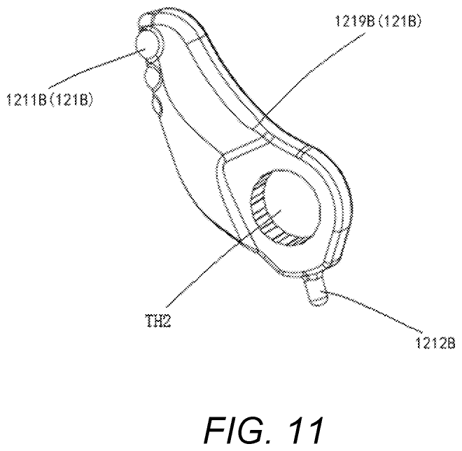

Furthermore, as shown in FIGS. 5 and 9, the first treatment arm 12A has: a first main body 121A, which is provided with a first massage portion 1211A; and a first restricted portion 1212A, which is fixed relative to the first main body 121A. As shown in FIGS. 5 and 11, the second treatment arm 12B has: a second main body 121B, which is provided with a second massage portion 1211B; and a second restricted portion 1212B, which is fixed relative to the second main body 121B. The first massage portion 1211A and the second massage portion 1211B face each other at intervals, and massage the shoulders of the subject being treated, respectively. The first restricted portion 1212A and the second restricted portion 1212B are inserted into the pair of guide slots 2221 of the support body 2, respectively, thereby restricting the first treatment arm 12A and the second treatment arm 12B from rotating along with the rotation of the rotating shaft 11. Specifically, the pair of guide slots 2221 of the support body 2 restricts the motion of the first restricted portion 1212A and the second restricted portion 1212B in the circumferential direction of the rotating shaft 11, but allows the motion of the first restricted portion 1212A and the second restricted portion 1212B in the radial direction of the rotating shaft 11 and in the extending direction of the rotating shaft 11.

### (First Treatment Arm and Support Structure Thereof)

As described above, the first treatment arm 12A has: the first main body 121A, which is provided with the first massage portion 1211A; and the first restricted portion 1212A, which is fixed relative to the first main body 121A.

Here, as shown in FIGS. 5 to 7 and 9, the first main body 121A has a first extended portion, i.e., a first plate-shaped portion 1219A, which extends in a direction intersecting with the rotating shaft 11. A protruding portion 1218A protruding toward the second treatment arm 12B is formed at an end of the first plate-shaped portion 1219A opposite to the guide slot 2221. In the illustrated example, the protruding portion 1218A is formed in a columnar shape that is folded back toward the rotating shaft 11 from the end of the first plate-shaped portion 1219A opposite to the guide slot 2221. However, the present invention is not limited to this configuration. The first massage portion 1211A is disposed at the front end of the protruding portion 1218A.

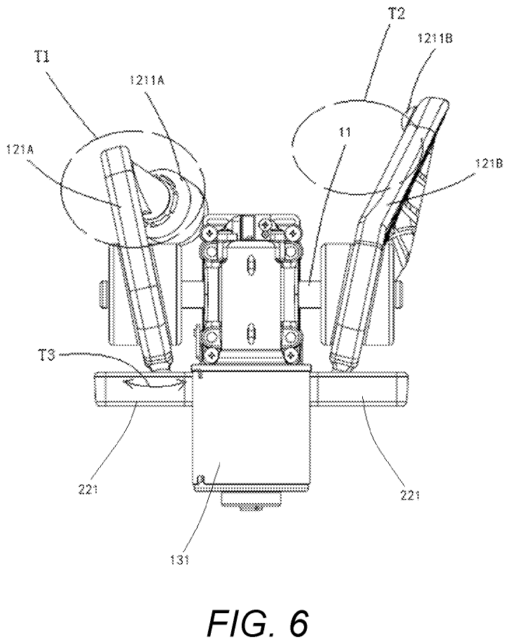

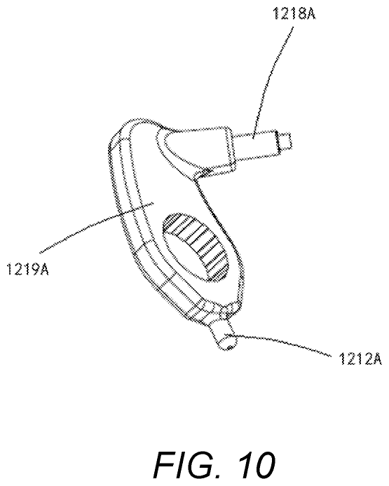

Furthermore, as shown in FIGS. 9 and 10, the first massage portion 1211A is detachably disposed on the first main body 121A (in the illustrated example, the first massage portion is sleeved on the front end of the protruding portion 1218A, however, the present invention is not limited to this configuration). The portion of the first massage portion 1211A in contact with the portion being treated is spherical. Moreover, as shown in FIG. 6, the motion trajectory T1 of the first massage portion 1211A is formed, for example, in a closed shape in which a span in the extending direction of the rotating shaft 11 is larger than a span in the radial direction of the rotating shaft 11.

Furthermore, as shown in FIGS. 9 and 10, the first restricted portion 1212A is integrally formed with the first main body 121A. The first restricted portion 1212A protrudes from the first main body 121A toward a direction away from the first massage portion 1211A. Moreover, as shown in FIG. 5, the first restricted portion 1212A is a cylindrical protrusion (also called a pin) protruding from the first main body 121A toward the guide slot 2221.

Furthermore, as shown in FIGS. 5 to 8, the first treatment arm 12A is supported on the rotating shaft 11 via the first cam component 16A eccentrically and obliquely with respect to the rotating shaft 11. The first cam component 16A is sleeved on the rotating shaft 11 in an eccentric manner relative to the rotating shaft 11. The first cam component 16A includes a first barrel portion 161A sleeved on the rotating shaft 11 and a first cover portion 162A. The first barrel portion 161A and the first cover portion 162A form a first cam slot GV1. The first barrel portion 161A is fixed to the rotating shaft 11, and has a first major-diameter portion P11 arranged in the extending direction of the rotating shaft 11 and a first minor-diameter portion P12 with an outer diameter smaller than that of the first major-diameter portion P11. The first cover portion 162A has an outer diameter larger than that of the first minor-diameter portion P12. The first cover portion 162A is assembled to the first barrel portion 161A from the side opposite to the first major-diameter portion P11 with respect to the first minor-diameter portion P12. The end surface of the first major-diameter portion P11 on the side of the first minor-diameter portion P12 is not orthogonal to the extending direction of the rotating shaft 11, with an angle A formed thereby being less than 90 degrees. An angle B formed by the end surface of the first cover portion 162A on the side of the first minor-diameter portion P12 and the extending direction of the rotating shaft 11 is also less than 90 degrees. In this embodiment, the angle A is the same as the angle B. That is, the end surface of the first major-diameter portion P11 on the side of the first minor-diameter portion P12 and the end surface of the first cover portion 162A on the side of the first minor-diameter portion P12 are opposite and parallel to each other, and both have the same inclination angle with respect to the rotating shaft 11. The end surface of the first major-diameter portion P11 on the side of the first minor-diameter portion P12 and the end surface of the first cover portion 162A on the side of the first minor-diameter portion P12 form side wall surfaces of the first cam slot GV1 and form the extending direction of the first cam slot GV1. When the first barrel portion 161A is mounted on the rotating shaft 11, the outer peripheral surface of the first minor-diameter portion P12 is inclined with respect to the rotating shaft 11 by an inclination angle C. The outer peripheral surface of the first minor-diameter portion P12 constitutes the bottom surface of the first cam slot GV1. Therefore, the first cam slot GV1 is eccentric with respect to the rotating shaft 11, and its extending direction and bottom surface are inclined with respect to the rotating shaft 11.

Furthermore, as shown in FIGS. 5, 9 and 10, the first main body 121A of the first treatment arm 12A has a first through hole TH1 through which the first minor-diameter portion P12 of the first barrel portion 161A penetrates and the shape of which matches that of the first cam slot GV1. The first treatment arm 12A is sleeved in the first cam slot GV1 through its first through hole TH1, and the first barrel portion 161A (specifically, the first major-diameter portion P11) and the first cover portion 162A define both ends of the first minor-diameter portion P12 respectively from both sides in the extending direction of the rotating shaft 11, thereby forming the first cam slot GV1.

### (Second Treatment Arm and Support Structure Thereof)

As described above, the second treatment arm 12B includes: a second main body 121B, which is provided with a second massage portion 1211B; and a second restricted portion 1212B, which is fixed relative to the second main body 121B.

Here, as shown in FIGS. 5 to 7 and 11, the second main body 121B has a second extended portion, i.e., a second plate-shaped portion 1219B, which extends in a direction intersecting with the rotating shaft 11. The second massage portion 1211B is disposed at the end of the second plate-shaped portion 1219B opposite to the guide slot 2221. The size of the second main body 121B in the radial direction of the rotating shaft 11 is larger than the size of the first main body 121A in the radial direction of the rotating shaft 11.

Furthermore, as shown in FIG. 11, the second massage portion 1211B is integrally formed with the second main body 121B. Similar to the first massage portion 1211A, the portion of the second massage portion 1211B in contact with the portion being treated is spherical. However, the shape of the second massage portion 1211B is different from the shape of the first massage portion 1211A. As shown in FIG. 6, like the first massage portion 1211A, the motion trajectory T2 of the second massage portion 1211B is formed, for example, in a closed shape in which a span in the extending direction of the rotating shaft 11 is larger than a span in the radial direction of the rotating shaft 11. However, the motion trajectory T2 of the second massage portion 1211B is different from the motion trajectory T1 of the first massage portion 1211A. Moreover, a plurality of second massage portions 1211B are arranged in the extending direction of the second plate-shaped portion 1219B.

Furthermore, as shown in FIG. 11, the second restricted portion 1212B is integrally formed with the second main body 121B. The second restricted portion 1212B protrudes from the second main body 121B toward a direction away from the second massage portion 1211B. Moreover, as shown in FIG. 5, the second restricted portion 1212B is a cylindrical protrusion (also called a pin) protruding from the second main body 121B toward the guide slot 2221.

Furthermore, as shown in FIGS. 5 to 8, the second treatment arm 12B is supported on the rotating shaft 11 via the second cam component 16B eccentrically and obliquely with respect to the rotating shaft 11 (in the state shown in FIG. 6, the first treatment arm 12A and the second treatment arm 12B are generally formed in a splayed shape). The second cam component 16B includes a second barrel portion 161B and a second cover portion 162B, which are sleeved on the rotating shaft 11. The second barrel portion 161B is fixed to the rotating shaft 11, and has a second major-diameter portion P21 arranged in the extending direction of the rotating shaft 11 and a second minor-diameter portion P22 with an outer diameter smaller than that of the second major-diameter portion P21. The second cover portion 162B has an outer diameter larger than that of the second minor-diameter portion P22. The second cover portion 162B is assembled onto the second barrel portion 161B from the side opposite to the second major-diameter portion P21 with respect to the second minor-diameter portion P22. The end surface of the second major-diameter portion P21 on the side of the second minor-diameter portion P22 is not orthogonal to the extending direction of the rotating shaft 11, with an angle D formed thereby being less than 90 degrees. An angle E formed by the end surface of the second cover portion 162B on the side of the second minor-diameter portion P22 and the extending direction of the rotating shaft 11 is also less than 90 degrees. In this embodiment, the angle D is the same as the angle E (in the illustrated example, the angle D is the same as the angle A). That is, the end surface of the second major-diameter portion P21 on the side of the second minor-diameter portion P22 and the end surface of the second cover portion 162B on the side of the second minor-diameter portion P22 are opposite and parallel to each other, and both have the same inclination angle with respect to the rotating shaft 11. The end surface of the second major-diameter portion P21 on the side of the second minor-diameter portion P22 and the end surface of the second cover portion 162B on the side of the second minor-diameter portion P22 form side wall surfaces of the second cam slot GV2 and define the extending direction of the second cam slot GV2. When the second barrel portion 161B is mounted on the rotating shaft 11, the outer peripheral surface of the second minor-diameter portion P22 is inclined with respect to the rotating shaft 11 by an inclination angle F (in the illustrated example, the angle F is the same as the angle C). The outer peripheral surface of the second minor-diameter portion P22 constitutes the bottom surface of the second cam slot GV2. Therefore, the second cam slot GV2 is eccentric with respect to the rotating shaft 11, and its extending direction and bottom surface are inclined with respect to the rotating shaft 11.

Furthermore, as shown in FIGS. 5 and 11, the second main body 121B of the second treatment arm 12B has a second through hole TH2 through which the second minor-diameter portion P22 of the second barrel portion 161B penetrates and the shape of which matches that of the second cam slot GV2. The second treatment arm 12B is sleeved in the second cam slot GV2 through its second through hole TH2, and the second barrel portion 161B (specifically, the second major-diameter portion P21) and the second cover portion 162B define both ends of the second minor-diameter portion P22 from both sides in the extending direction of the rotating shaft 11, thereby forming the second cam slot GV2.

### (Structure of the Guide Slot)

As described above, the guide slots 2221 restrict the first treatment arm 12A and the second treatment arm 12B from rotating irregularly along with the rotation of the rotating shaft 11.

Here, as shown in FIG. 5, the guide slots 2221 include a first guide slot 2221A and a second guide slot 2221B. The first guide slot 2221A allows for insertion of the first restricted portion 1212A, and the second guide slot 2221B allows for insertion of the second restricted portion 1212B. When the rotating shaft 11 rotates, the top ends of the first restricted portion 1212A and the second restricted portion 1212B move in an arc shape within the first guide slot 2221A and the second guide slot 2221B.

Furthermore, as shown in FIG. 5, the first guide slot 2221A and the second guide slot 2221B are located on both sides of the retaining seat 14 in the extending direction of the rotating shaft 11.

Here, the first guide slot 2221A is taken as an example to describe the structure of the guide slot and the cooperation between the guide slot and the restricted portion. As shown in FIG. 5, the first guide slot 2221A extends in parallel to the rotating shaft 11, that is, the length direction of the first guide slot 2221A is consistent with the extending direction of the rotating shaft 11. The first restricted portion 1212A is slidable in the length direction of the first guide slot 2221A. The slot width direction of the first guide slot 2221A intersects with (in this embodiment, orthogonal to) the extending direction of the rotating shaft 11. The size of the slot width of the first guide slot 2221A is substantially the same as the size of the first restricted portion 1212A in the slot width direction. The first restricted portion 1212A is slidable in the length direction of the first guide slot 2221A, but is not slidable in the width direction of the first guide slot 2221A. In this embodiment, since the slot width direction of the first guide slot 2221A is orthogonal to the extending direction of the rotating shaft 11 (i.e., in the circumferential direction of the rotating shaft 11), the motion of the first restricted portion 1212A in the circumferential direction of the rotating shaft 11 can be regulated. When the first treatment arm 12A rotates via an eccentric cam structure along with the rotation of the rotating shaft 11, it will not cause any motion in the circumferential direction of the rotating shaft 11. At this point, the first restricted portion 1212A moves along the arc-shaped motion trajectory T3 shown in FIG. 6.

Furthermore, as shown in FIG. 5, the slot depth direction of the first guide slot 2221A is in the radial direction of the rotating shaft 11. The first restricted portion 1212A is inserted into the first guide slot 2221A. The first guide slot 2221A restricts the first restricted portion 1212A from moving in the slot width direction, but allows the first restricted portion 1212A to move in the slot length direction and the slot depth direction. The depth of the first guide slot 2221A in the slot depth direction is greater than the movement distance of the first restricted portion 1212A in the radial direction of the rotating shaft 11 as the rotating shaft 11 rotates. In this embodiment, the first guide slot 2221A is a through groove, such that there is no need to overly consider the dimensional relationship between the slot depth and the first restricted portion 1212A, making it possible to increase the degree of freedom during assembling.

### (Structure of the Drive Mechanism)

As shown in FIGS. 5, 7 and 8, the drive mechanism 13 includes an electronic motor or actuator 131 and a transmission mechanism 132.

Here, as shown in FIG. 5, the motor 131 is disposed between the first treatment arm 12A and the second treatment arm 12B in the extending direction of the rotating shaft 11, and extends perpendicularly to the rotating shaft 11. The motor 131 has a motor housing 1311 connected to the retaining seat 14 and a drive shaft 1312 rotatably supported by the motor housing 1311. The drive shaft 1312 extends perpendicularly to the rotating shaft 11.

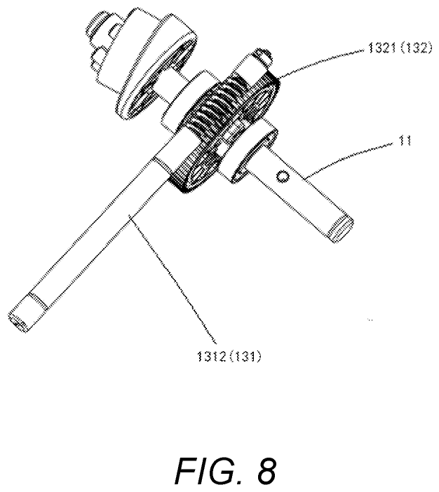

Furthermore, as shown in FIGS. 7 and 8, the transmission mechanism 132 transmits the driving force of the motor 131 to the rotating shaft 11 to actuate the rotating shaft 11 to rotate. The transmission mechanism 132 includes a worm wheel 1321. The worm wheel 1321 is mounted on the middle portion of the rotating shaft 11 (in the illustrated example, the portion between the first bearing 151A and the second bearing 152A), is accommodated in the retaining seat 14, and meshes with a thread formed on the outer peripheral surface of the drive shaft 1312, thereby transmitting the driving force of the motor 131 to the rotating shaft 11. Moreover, the first treatment arm 12A and the second treatment arm 12B protrude toward a direction further away from the guide slot 2221 than the transmission mechanism 132.

### (Structure of the Retaining Seat)

As described above, the retaining seat 14 is fixed to the support body 2.

Here, as shown in FIG. 5, the retaining seat 14 is fixed to the support body 2 from above. In this embodiment, the retaining seat 14 is fixed to a portion of the support plate 21 that protrudes further toward the inner side in the shoulder width direction than the first hood 22.

Furthermore, as shown in FIG. 5, the retaining seat 14 is an annular housing surrounding a central portion of the rotating shaft 11 in the extending direction. Furthermore, as shown in FIG. 7, the retaining seat 14 supports the rotating shaft 11 for rotation via the first bearing 151A and the second bearing 152A.

### 3) Specific Structure of the Force Application Portion

In this embodiment, the force application portion S3 drives the movable portion S2 to move back and forth between the retracted position and the extended position in the left-to-right direction. The force application portion S3 is located between the movable portion S2 and the connecting arm 92 of the fixed portion S1. The left and right ends of the force application portion 3 are connected to the movable portion S2 and the connecting arm 92 of the fixed portion S1, respectively.

Here, as shown in FIG. 5, the force application portion S3 has a telescopic component 80 that extends and retracts to enable the movable portion S2 to move back and forth.

Furthermore, as shown in FIG. 5, the telescopic component 80 includes an elastic component 81, and the elastic component 81 is disposed between the fixed portion S1 and the movable portion S2, and applies force to the movable portion S2 toward the outer side in the shoulder width direction. In this embodiment, the elastic component 81 is a coil spring (in the illustrated example, an extension coil spring), with one end connected to the support body 2 of the movable portion S2, and the other end connected to the base 91 (in the illustrated example, the side plate 912) of the fixed portion S1. A pair of elastic components 81 is arranged spaced apart in the front-to-back direction (in the illustrated example, the elastic components 81 are located between the guide rails 913 and the reinforcing plates 915 in the front-to-back direction).

Furthermore, as shown in FIG. 5, the telescopic component 80 includes an air bag 82. The air bag 82 is disposed between the fixed portion S1 and the movable portion S2 and is connected to the fixed portion S1. Both ends of the airbag 82 in the front-to-back direction are connected to the connecting arm 92 of the fixed portion S1, respectively. During inflation, the airbag 82 expands towards the inner side in the shoulder width direction with the connecting arm 92 fixed in the left-to-right direction as a support, applying a force to the movable portion S2. In this embodiment, two airbags 82 are arranged side by side in the shoulder width direction. There can be a plurality of airbags 82. For example, the individual airbags 82 are fixedly connected to each other in a ventilatable manner and arranged in the left-to-right direction. Both ends of the inner airbag 82 in the front-to-back direction are connected to the movable portion S2, and both ends of the outer airbag 82 in the front-to-back direction are connected to the connecting arm 92 of the fixed portion S1. Therefore, it is easy to control the inflation direction of the plurality of airbags 82 as a whole even in a state where the plurality of airbags 82 is provided, i.e., ensuring that the plurality of airbags 82, when inflated, push the movable portion S2 in the desired left-to-right direction.

### 4) Specific Structure of the Detection Portion

As described above, the detection portion S4 detects the position of the movable portion S2 relative to the fixed portion S1.

Here, as shown in FIGS. 4A, 4B and 5, the detection portion S4 includes a detected element 71 and a detecting element 72. The detected element 71 is disposed on one of the fixed portion S1 and the movable portion S2, and the detecting element 72 is disposed on the other of the fixed portion S1 and the movable portion S2. In this embodiment, the detected element 71 is a magnet and is disposed on the base 91 (in the illustrated example, the bottom plate 911) of the fixed portion S1. The detecting element 72 is a Hall element (in the illustrated example, disposed on a circuit board), and is disposed in a support body 2 of the movable portion S2 (in the illustrated example, inside the first hood 22) . Thus, in the illustrated embodiment, the detection portion S4 includes a Hall-effect sensor or detector, but the present invention is not limited to this. The detection portion S4 can include any other suitable sensor configured to detect the position of the movable portion S2 relative to the fixed portion S1, such as an optical sensor, a reed switch, a microswitch, an encoder, etc.

In this embodiment, the first hood 22 is provided with detecting elements 72 at two positions therein, respectively. The detecting elements 72 at the two positions correspond to the retracted position and the extended position of the movable portion S2, respectively, allowing for detecting whether the movable portion S2 is in the retracted position (see FIG. 4A) or the extended position (see FIG. 4B), respectively.

### Overview of Massager Actions

In this embodiment, when the shoulder treatment units S are in a standby state, for example, before a subject to be treated sits on the massager A, the movable portion S2 is in the retracted position relative to the fixed portion S1 under the action of the force application portion S3.

In the above state, the subject to be treated sits on the massager A, and then the massager A is started.

At this point, if the shoulder treatment units S are started, the control portions C control the force application portions S3 to apply a force to the movable portions S2 to actuate the movable portions S2 to move toward the inner side in the left-to-right direction. Therefore, the movable portions S2 move toward the inner side in the shoulder width direction with respect to the fixed portion S1. Specifically, in this embodiment, by inflating the airbags 82, the airbags 82 expand to increase the distance between the movable portions S2 and the connecting arms 92, thereby reducing the distance between the treatment assemblies 1 on the left and right sides in the left-to-right direction. That is, the treatment assemblies 1 are moved inward along the shoulder width of the subject being treated.

When the movable portions S2 move toward the inner side in the shoulder width direction with respect to the fixed portions S1, if the detection portions S4 detect that the movable portions S2 reach preset positions, the control portions C stop further movement of the movable portions S2 by means of the force application portions S3 (for example, keeping the pressure in the airbags 82 at a constant value). Besides, when the movable portions S2 move toward the inner side in the shoulder width direction from the retracted positions, the protrusions 24 slide along the grooves 9131, such that the upper limits of the moving distances of the movable portions S2 can also be defined by means of the movement restriction structures.

Then, the control portion C actuates the motor 131 to operate, thereby enabling the first massage portion 1211A and the second massage portion 1211B to repeatedly perform the actions of approaching each other and then separating. That is, when approaching each other, the first massage portion 1211A and the second massage portion 1211B approach the portion being treated from both sides of the portion being treated, such that each of the first massage portion and the second massage portion applies a force to the portion being treated from its own side toward the other massage portion, to gradually tightly clamp the portion being treated. When separating after approaching each other, the first massage portion 1211A and the second massage portion 1211B each start to move from the closest position toward a direction where they move away. Therefore, the actions of approaching each other and separating from each other are performed repeatedly to perform massaging.

After the treatment has been completed, the control portions C control the force application portions S3 (specifically, by deflating the airbags 82), thereby enabling the movable portions S2 to move toward the outer side in the shoulder width direction with respect to the fixed portions S1.

According to the massager A in this embodiment, each shoulder treatment unit S includes: a fixed portion S1, which is connected and fixed to the frame J; a movable portion S2, which has a treatment assembly 1, is supported on the frame J via the fixed portion S1, and can move in the shoulder-width direction with respect to the fixed portion S1; and a force application portion S3, which drives the movable portion S2 to move back and forth. Therefore, when a subject being treated gets up after the treatment is completed, the movable portion S2 having the treatment assembly 1 can be prevented from interfering with the shoulders of the subject being treated, by moving the movable portion S2 toward the outer side in the shoulder width direction using the force application portion S3, thereby making it easily for a subject being treated to get up.

Furthermore, according to the massager A in this embodiment, in each shoulder treatment unit S, the first treatment arm 12A includes: a first main body 121A provided with a first massage portion 1211A; and a first restricted portion 1212A fixed relative to the first main body 121A. A guide slot 2221 cooperates with the first restricted portion 1212A, thereby restricting the first restricted portion 1212A from moving in the circumferential direction of the rotating shaft 11, but allowing the first restricted portion 1212A to move in the radial direction of the rotating shaft 11 and in the extending direction of the rotating shaft 11. The second treatment arm 12B includes: a second main body 121B provided with a second massage portion 1211B; and a second restricted portion 1212B fixed relative to the second main body 121B. A guide slot 2221 cooperates with the second restricted portion 1212B, thereby restricting the second restricted portion 1212B from moving in the circumferential direction of the rotating shaft 11, but allowing the second restricted portion 1212B to move in the radial direction of the rotating shaft 11 and in the extending direction of the rotating shaft 11. Therefore, this helps to simplify the overall structure and reduce the manufacturing costs.

The present disclosure has been described by way of example with reference to the accompanying drawings. Obviously, the specific implementation of the present invention is not limited by the embodiments described above.

For example, in the embodiment described above, the massager A is a massage chair. However, the present invention is not limited to this configuration. Alternatively, the massager can be another device such as a massage bed.

Furthermore, in the embodiment described above, a pair of shoulder treatment units S are arranged in the shoulder width direction. However, the present invention is not limited to this configuration. Alternatively, only one shoulder treatment unit can be provided depending on the situation.

Furthermore, in the embodiment described above, the shoulder treatment unit S can be configured to be able to move in the up-and-down direction relative to the frame J. For example, the fixed portion S1 and the frame J are configured to be connected through sliding rails.

Furthermore, in the embodiment described above, the telescopic component 80 includes an elastic component 81 and an airbag 82. However, the present invention is not limited to this configuration. Alternatively, a cylinder or the like can be used instead of the elastic component 81 and the airbag 82.

Furthermore, in the embodiment described above, the force application portion S3 has the telescopic component 80 that extends and retracts to enable the movable portion S2 to move back and forth. However, the present invention is not limited to this configuration. Alternatively, the force application portion S3 can have a stepping motor or the like instead of the telescopic component 80.

Furthermore, in the embodiment described above, the eccentricity of the first treatment arm 12A relative to the rotating shaft 11 is the same as the eccentricity of the second treatment arm 12B relative to the rotating shaft 11. However, the present invention is not limited to this configuration. Alternatively, the eccentricity of the first treatment arm 12A relative to the rotating shaft 11 can be configured to be different from the eccentricity of the second treatment arm 12B relative to the rotating shaft 11.

Furthermore, in the embodiment described above, the angle A and the angle D are the same, that is, the inclination of the first treatment arm 12A relative to the rotating shaft 11 and the inclination of the second treatment arm 12B relative to the rotating shaft 11 are the same. However, the present invention is not limited to this configuration. Alternatively, the angle A and the angle D can be set to be different. That is, the inclination of the first treatment arm 12A relative to the rotating shaft 11 and the inclination of the second treatment arm 12B relative to the rotating shaft 11 are different.

Furthermore, in the embodiment described above, a portion of each of the massage portions of the first treatment arm 12A and the second treatment arm 12B, in contact with the portion being treated, is spherical. However, the present invention is not limited to this configuration, and the shape can alternatively be appropriately changed as needed.

Furthermore, in the embodiment described above, the first restricted portion 1212A is integrally formed with the first main body 121A, and the second restricted portion 1212B is integrally formed with the second main body 121B. However, the present invention is not limited to this configuration. Alternatively, the first restricted portion 1212A can be formed separately from the first main body 121A and connected and fixed thereto, and the second restricted portion 1212B can be formed separately from the second main body 121B and connected and fixed thereto.

Furthermore, in the embodiment described above, the motion trajectory of the second massage portion 1211B can Alternatively be the same as the motion trajectory of the first massage portion 1211A.

Furthermore, in the embodiment described above, the shape of the second massage portion 1211B can Alternatively be the same as the shape of the first massage portion 1211A.

Furthermore, in the embodiment described above, the shapes of the first main body 121A and the second main body 121B are not limited to the illustrated shapes, and can be appropriately changed as needed.

Furthermore, in the embodiment described above, the motor 131 is disposed between the first treatment arm 12A and the second treatment arm 12B in the extending direction of the rotating shaft 11. However, the present invention is not limited to this configuration. Alternatively, the position of the motor 131 can be appropriately modified as needed.

Furthermore, in the embodiment described above, the first treatment arm 12A and the second treatment arm 12B are each eccentric and inclined relative to the rotating shaft 11. However, the present invention is not limited to this configuration. Alternatively, only one of the first treatment arm 12A and the second treatment arm 12B can be configured to be eccentric and inclined relative to the rotating shaft 11.

Furthermore, in the embodiment described above, the first treatment arm 12A abuts against the shoulder of the subject being treated from the front side for massaging, and the second treatment arm 12B abuts against the shoulder of the subject being treated from the back side for massaging. However, the present invention is not limited to this configuration. Alternatively, the first treatment arm 12A can be configured to abut against the shoulder of the subject being treated from the back side for massaging, and the second treatment arm 12B can be configured to abut against the shoulder of the subject being treated from the front side for massaging.

Furthermore, in the embodiment described above, the treatment assembly 1 is arranged in such a way that the axial direction of the motor 131 is consistent with the shoulder width direction of the subject being treated. However, the present invention is not limited to this configuration. Alternatively, the treatment assembly 1 can also be configured such that the axial direction of the motor 131 intersects with the shoulder width direction of the subject being treated.

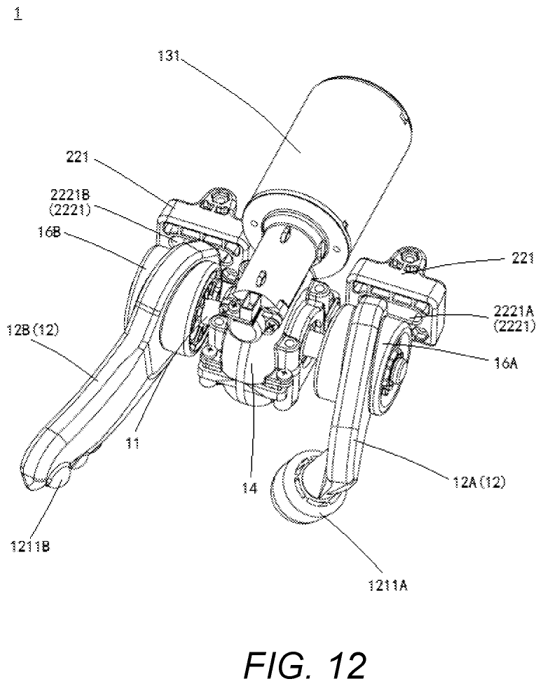

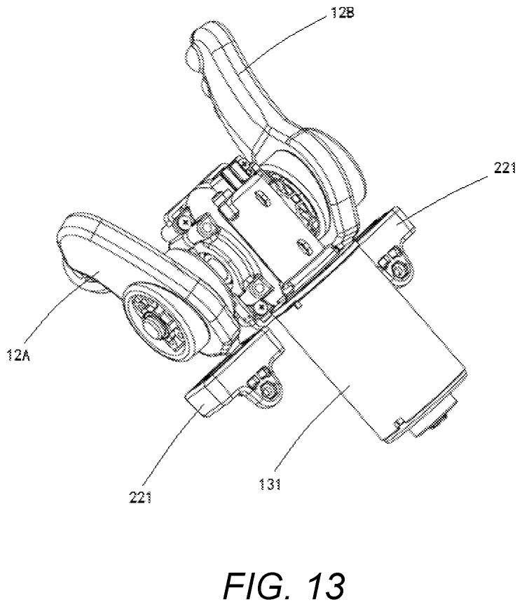

Furthermore, in the embodiment described above, as shown in FIGS. 12 and 13, the size of the motor 131 can be appropriately selected as needed.

Furthermore, in the embodiment described above, the detection portion S4 detects the position of the movable portion S2 relative to the fixed portion S1. However, the present invention is not limited to this configuration. Alternatively, the detection unit S4 can be configured to detect the relative position between the movable portions S2 on the left and right sides.

It should be understood that within the scope of the present invention, various parts of the embodiments can be freely combined, or appropriately modified or omitted.

What is claimed is:

1. A treatment mechanism, comprising:
a rotating shaft;
a first treatment arm and a second treatment arm rotatably disposed on the rotating shaft at intervals and having massage portions configured to massage a portion being treated, in a manner of approaching each other, with at least one of the first treatment arm and the second treatment arm being eccentric and inclined relative to the rotating shaft; and
a restricting portion configured to restrict the first treatment arm and the second treatment arm from rotating along with rotation of the rotating shaft,
the at least one of the first treatment arm and the second treatment arm including a main body provided with the massage portion, and a restricted portion fixed relative to the main body, and
the restricting portion cooperating with the restricted portion to restrict the restricted portion from moving in a circumferential direction of the rotating shaft, while allowing the restricted portion to move in a radial direction of the rotating shaft and in an extending direction of the rotating shaft.

2. The treatment mechanism according to claim 1, wherein
in the at least one of the first treatment arm and the second treatment arm, the restricted portion is integrally formed with the main body.

3. The treatment mechanism according to claim 1, wherein
the restricting portion is provided with a guide slot,
the guide slot extends in parallel to the rotating shaft and is configured to allow for insertion of the restricted portion, and
the guide slot is configured to restrict the restricted portion from moving in a slot width direction, while allowing the restricted portion to move in a slot length direction and a slot depth direction.

4. The treatment mechanism according to claim 1, wherein
the massage portion of the first treatment arm and the massage portion of the second treatment arm have different motion trajectories.

5. The treatment mechanism according to claim 1, wherein
the massage portion of the first treatment arm and the massage portion of the second treatment arm have different shapes.

6. The treatment mechanism according to claim 1, wherein
the first treatment arm and the second treatment arm each include the main body and the restricted portion fixed relative to the main body, and
the massage portion of the first treatment arm is detachably disposed on the main body of the first treatment arm.

7. The treatment mechanism according to claim 1, wherein
a portion of at least one of the massage portions of the first treatment arm and the second treatment arm, in contact with the portion being treated, is spherical.

8. The treatment mechanism according to claim 1, wherein
the second treatment arm is provided with a plurality of massage portions arranged in a straight line.

9. The treatment mechanism according to claim 1, wherein
the first treatment arm and the second treatment arm are each eccentric and inclined relative to the rotating shaft,
an eccentricity of the first treatment arm relative to the rotating shaft is different from an eccentricity of the second treatment arm relative to the rotating shaft, and/or, an inclination of the first treatment arm relative to the rotating shaft is different from an inclination of the second treatment arm relative to the rotating shaft.

10. The treatment mechanism according to claim 1, further comprising:
a motor configured to drive the rotating shaft to rotate, the motor being disposed between the first treatment arm and the second treatment arm in the extending direction of the rotating shaft, and extending perpendicularly to the rotating shaft.

11. The treatment mechanism according to claim 1, wherein
the first treatment arm includes a first main body with a first massage portion, and a first restricted portion fixed relative to the first main body,
the second treatment arm includes a second main body with a second massage portion, and a second restricted portion fixed relative to the second main body,
the first main body has a first plate-like portion extending in a manner of intersecting with the rotating shaft, and a protruding portion protruding toward the second treatment arm at an end of the first plate-like portion opposite to the restricting portion, with the first massage portion being disposed at a front end of the protruding portion, and
the second main body has a second plate-like portion extending in a manner of intersecting with the rotating shaft, with the second massage portion being disposed at an end of the second plate-like portion opposite to the restricting portion.

12. A massager, comprising:
the treatment mechanism according to claim 1.

13. The massager according to claim 12, further comprising:
a frame; and
a shoulder treatment unit including
a fixed portion connected and fixed to the frame,
a movable portion having the treatment mechanism, the treatment mechanism being supported on the frame via the fixed portion and being movable in a shoulder width direction relative to the fixed portion, and
a force application portion configured to drive the movable portion to move back and forth.

14. The massager according to claim 13, wherein
the force application portion has a telescopic component that is configured to extend and retract to enable the movable portion to move back and forth.

15. The massager according to claim 14, wherein
the telescopic component includes an elastic component that is disposed between the fixed portion and the movable portion, the elastic component being configured to apply force to the movable portion toward an outer side in the shoulder width direction.

16. The massager according to claim 14, wherein
the telescopic component includes an airbag that is disposed between the fixed portion and the movable portion, the airbag being configured to apply, during inflation, a force to the movable portion toward an inner side in the shoulder width direction.

17. The massager according to claim 13, wherein
the fixed portion has a guide rail extending along the shoulder width direction, and
the movable portion has sliders engaged with the guide rail in a manner of enabling the sliders to slide relative to the guide rail.

18. The massager according to claim 17, wherein each of the sliders has
an upper abutting portion abutting against the guide rail from above, and
a lower abutting portion abutting against the guide rail from below.

19. The massager according to claim 13, further comprising:
a movement restriction structure disposed between the movable portion and the fixed portion.

20. The massager according to claim 13, wherein
the shoulder treatment unit includes a detection portion that is configured to detect movement of the movable portion.

21. The massager according to claim 20, wherein
the shoulder treatment unit includes a control portion that is configured to control an action of the force application portion based on a detection result of the detection portion.
